(19) United States
(12) Patent Application Publication
(10) Pub. No.: US 2011/0283547 A1
(43) Pub. Date: Nov. 24, 2011

(54) CUTTER HOLDER MADE OF CORK MATERIAL

(76) Inventor: Chie-Chiun WANG, Sijhih City (TW)

(21) Appl. No.: 12/782,019

(22) Filed: May 18, 2010

(51) Int. Cl. B26B 27/00

(52) U.S. Cl. 30/298.4

(57) ABSTRACT

A cutter holder having a holder block made of one single piece or multiple pieces of cork material and one or multiple cutter-resting devices defined in the holder block for the insertion of the cutter blade of one or a number of cutting tools.

### BACKGROUND OF THE INVENTION

1. Field of the Invention

The present invention relates to cutter holding devices and more particularly, to a cutter holder with at least one base body thereof made of cork material for use in kitchen for holding cutting tools safely.

2. Description of the Related Art

Many different designs of cutter holders of different materials, such as wood, metal or plastics, are commercially available. Wooden cutter holders are eco unfriendly products. Harvesting trees from forests for making wooden cutter holders results in forest loss. Forest loss results in emissions of carbon dioxide, worsening global warming. Furthermore, cork is a recyclable material and used in many other products and equipment such as coasters, paperweight, bookmarks, etc.

Further, regular metal cutter holders have the drawbacks of heavy weight and movement inconvenience. Further, metal material is slippery, not easy to grasp. Further, metal material does not facilitate shaping. Monotonous modeling of metal cutter holders cannot attract consumers. Further, plastic cutter holders have the advantage of lightweight and cheap cost. However cutting tools resting in a plastic cutter holder tend to get damp and moldy, facilitating the growth and development of bacteria. Furthermore, plastic material is not environmentally friendly.

Therefore, it is desirable to provide an eco-friendly cutter holder that eliminates the aforesaid drawbacks.

### SUMMARY OF THE INVENTION

The present invention has been accomplished under the circumstances in view. A cutter holder according to the present invention comprises a holder block made of one single piece or multiple pieces of cork material. The holder block has one or multiple insertion holes or cutter-resting devices for receiving the cutter blade of one or a number of cutting tools safely.

Because the holder block is made of cork material that is prime-subset of generic cork tissue that is harvested primarily from cork oak, the production of the cutter holder is eco-friendly. Subject to the use of cork material, the holder block has the characteristics of impermeability, buoyancy, elasticity, and fire resistance. When compared to conventional metal cutter holders, the cutter holder has advantages of ease of movement and non-slip.

Further, the characteristic of impermeability of the cork material of the holder block prevents cutting tools from getting damp or moldy, and inhibits the growth and development of bacteria. Further, cork material facilitates modeling. For example, the holder block can be easily made in a rectangular, cubic, triangular, upright or sloping shape.

Further, each insertion hole or cutter-resting device can be attached with an internal sheath made of a different material for protection. Further, the outside wall of the holder block may be covered with a decorative or functional shell.

Further, the outside wall of the holder block may be covered with covered with a covering that carries a design to attract people's eyes.

### BRIEF DESCRIPTION OF THE DRAWINGS

FIG. 1 is an oblique elevation of a cutter holder in accordance with a first embodiment of the present invention.

FIG. 2 is a schematic applied view of the cutter holder in accordance with the first embodiment of the present invention.

FIG. 3 is an oblique elevation of a cutter holder in accordance with a second embodiment of the present invention.

FIG. 4 is a sectional elevation of a cutter holder in accordance with the third embodiment of the present invention.

FIG. 5 is an oblique elevation of a cutter holder in accordance with a fourth embodiment of the present invention.

FIG. 6 is a sectional elevation of a cutter holder in accordance with a fifth embodiment of the present invention.

FIG. 7 is an elevational view of a cutter holder in accordance with a sixth embodiment of the present invention.

FIG. 8 is an elevational view of a cutter holder in accordance with a seventh embodiment of the present invention.

FIG. 9 illustrates an extended status of a cutter holder in accordance with the eighth embodiment of the present invention.

FIG. 10 is an elevational view of a cutter holder in accordance with a ninth embodiment of the present invention.

FIG. 11 is an elevational view of a cutter holder in accordance with tenth embodiment of the present invention.

### DETAILED DESCRIPTION OF THE PREFERRED EMBODIMENT

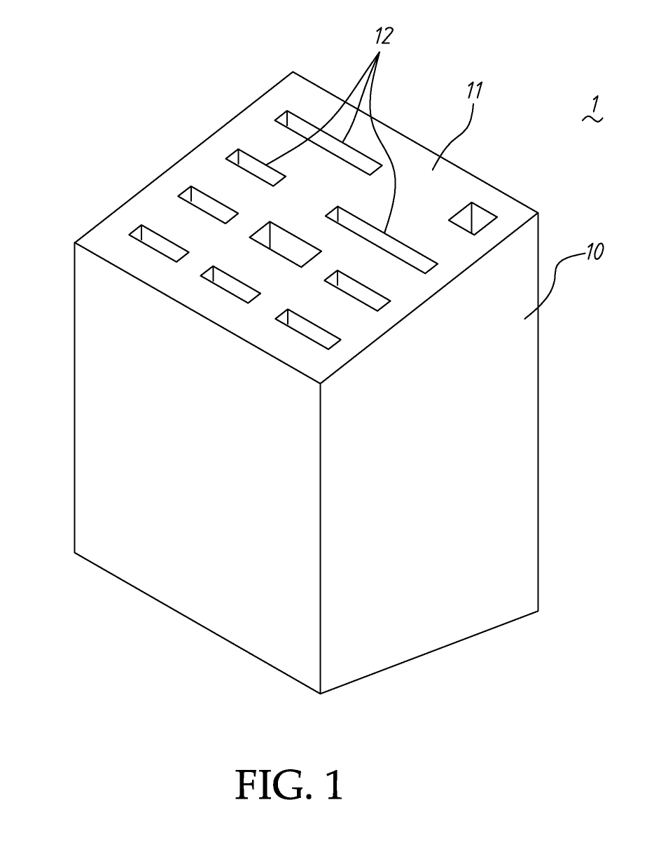

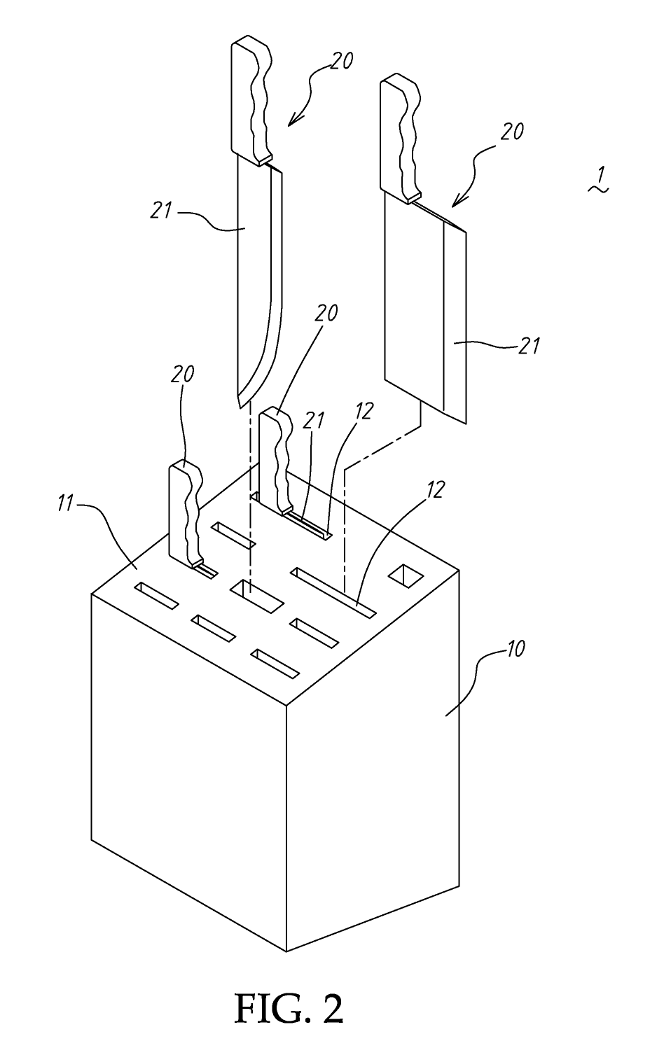

Referring to FIGS. 1 and 2, a cutter holder 1 in accordance with a first embodiment of the present invention is shown comprising a holder block 10 made of cork material. The holder block 10 has a top wall 11, and at least one, for example, multiple cutter-resting devices, for example, insertion holes 12 located on the top wall 11. As shown in FIG. 2, each insertion 12 allows insertion of the cutter blade 21 of one cutting tool 20. Thus, the holder block 10 can hold multiple cutting tools 20 safely. The insertion holes 12 can be blind holes, or through holes.

As stated above, the holder block 10 is made of cork material that is prime-subset of generic cork tissue that is harvested primarily from cork oak. Therefore, the production of the cutter holder 1 is eco-friendly when compared to conventional wooden cutter holders. Subject to the use of cork material, the holder block 10 has the characteristics of impermeability, buoyancy, elasticity, and fire resistance. When compared to conventional metal cutter holders, the cutter holder 1 has advantages of ease of movement and non-slip.

Further, the characteristic of impermeability of the cork material of the holder block 10 prevents cutting tools from getting damp or moldy, and inhibits the growth and development of bacteria. Further, cork material facilitates modeling. For example, the holder block 10 can be easily made in a rectangular, cubic, triangular, upright or sloping shape.

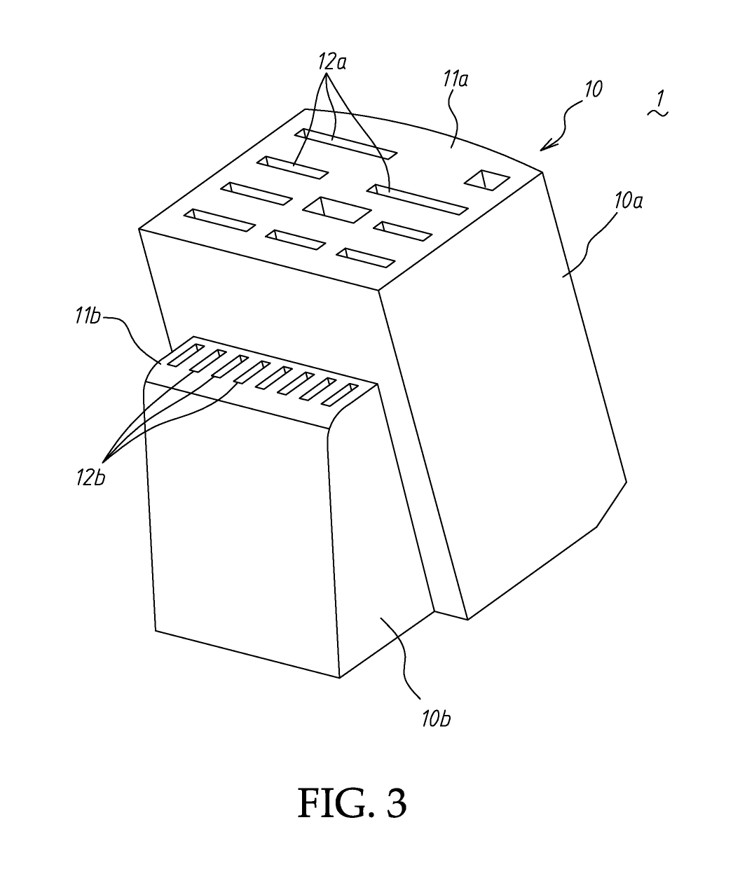

According to the first embodiment shown I FIG. 1, the holder block 10 of the cutter holder 1 is formed of one single piece of cork material. FIG. 3 illustrates a cutter holder in accordance with a second embodiment of the present invention. According to this second embodiment, the holder block 10 is formed of two cork material members 10a and 10b. Each cork material member 10a or 10b has a top wall 11a or 11b, and at least one, for example, multiple insertion holes 12a or 12b located on the top wall 11a or 11b for the insertion of the cutter blade 21 of a respective cutting tool 20. It is to be understood that the holder block 10 can be formed of more than two cork material members.

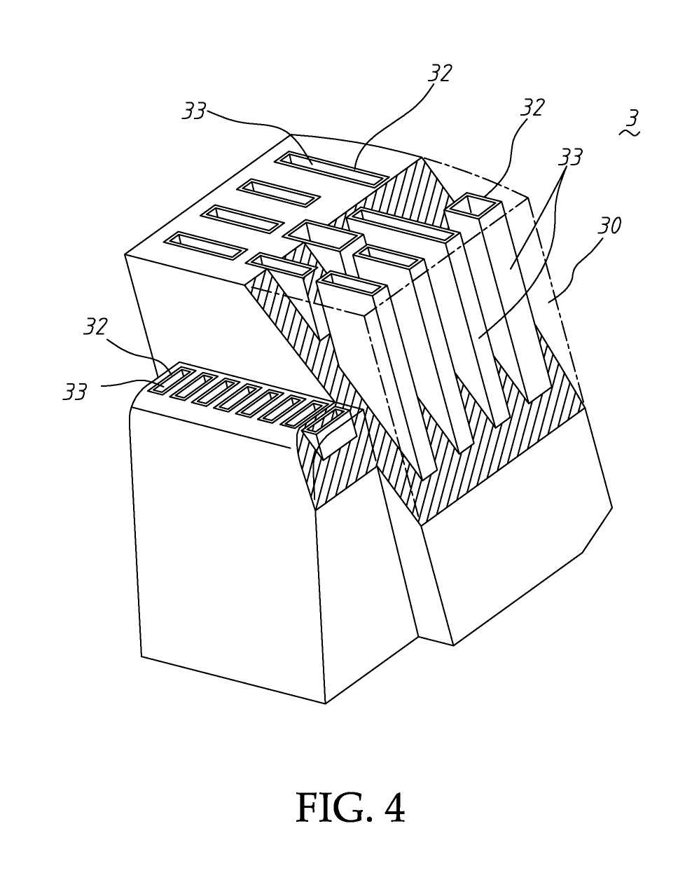

FIG. 4 illustrates a cutter holder in accordance with a third embodiment of the present invention. According to this third embodiment, each insertion hole 32 of the holder block 30 of the cutter holder 3 has an internal sheath 33 of a different material attached thereto for protection, avoiding damage to the tissue structure of the cork material by the cutter blade of a cutting tool.

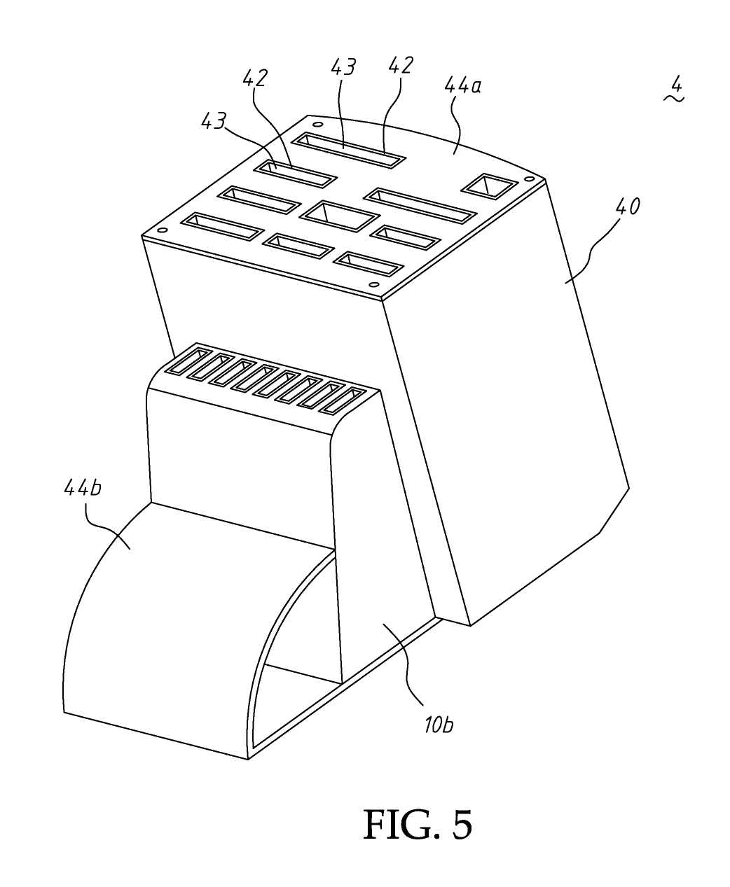

FIG. 5 illustrates a cutter holder in accordance with a fourth embodiment of the present invention. Similar to the aforesaid third embodiment, each insertion hole 42 of the holder block 40 of the cutter holder 4 in accordance with this fourth embodiment, has an internal sheath 43 of a different material attached thereto for protection. Further, a functional cover shell 44a is covered on the wall of the holder block 40 around each insertion hole 42. Further, the holder block 40 has an ornamental shell 44b attached to one cork material member 10b thereof. Further, the functional and/or ornamental block and parts of the cutter holder may be prepared from the combination of cork and other materials for either functional or ornamental purpose.

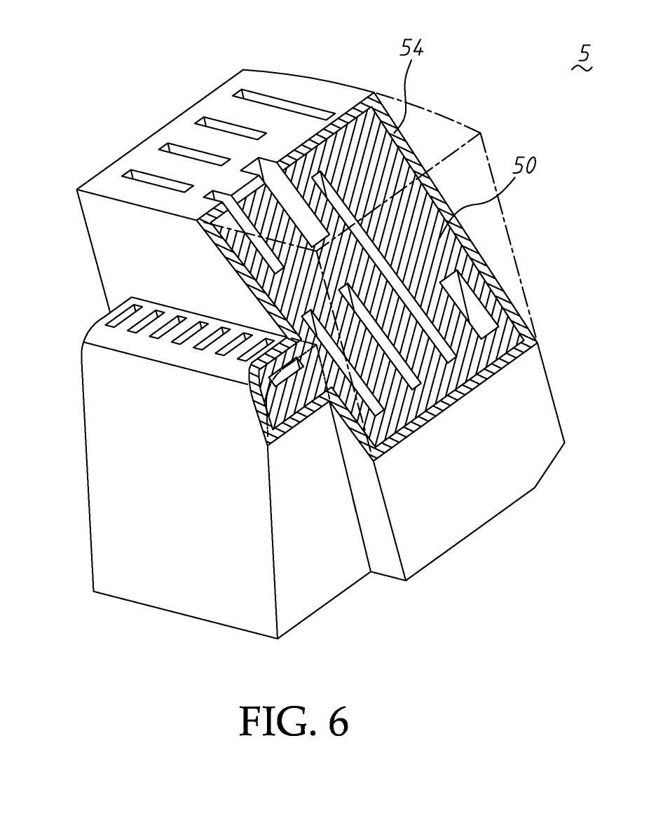

FIG. 6 illustrates a cutter holder in accordance with a fifth embodiment of the present invention. According to this fifth embodiment, the outside wall of the cork material of the holder block 50 of the cutter holder 5 is surrounded by a protective shell 54 of a different material for protection, avoiding damage to the tissue structure of the cork material by the cutter blade of a cutting tool, and prolonging the lifespan of the holder block 50.

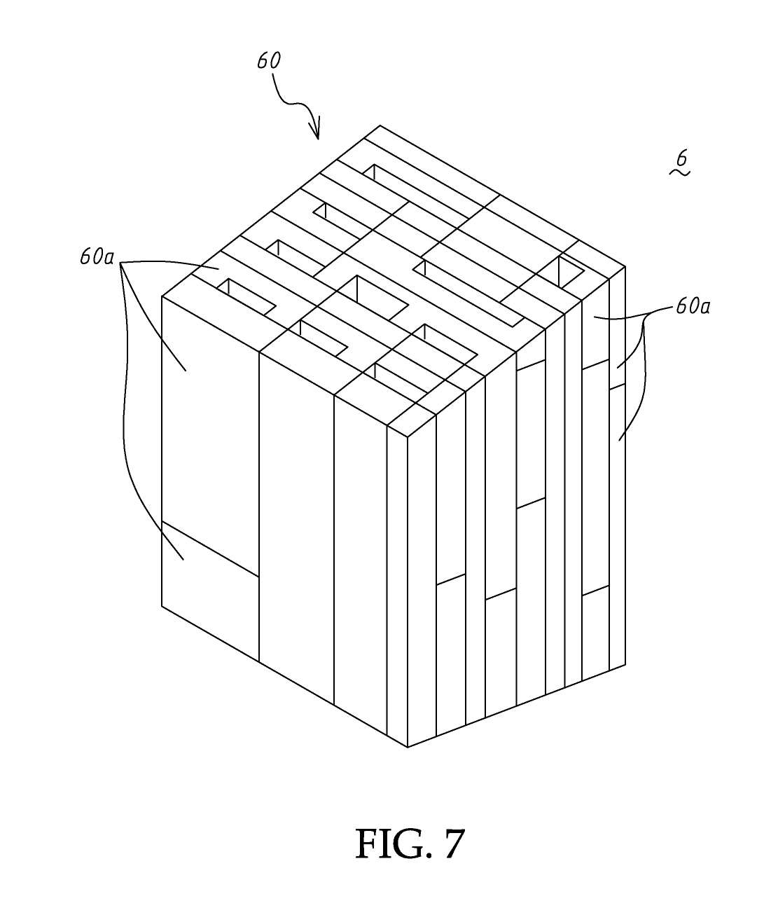

FIG. 7 is an elevational view of a cutter holder in accordance with the sixth embodiment of the present invention. According to this sixth embodiment, the holder block 60 of the cutter holder 6 is formed by bonding multiple cork material blocks 60a together by an adhesive, making the block more solid and stronger, and showing a sense of beauty.

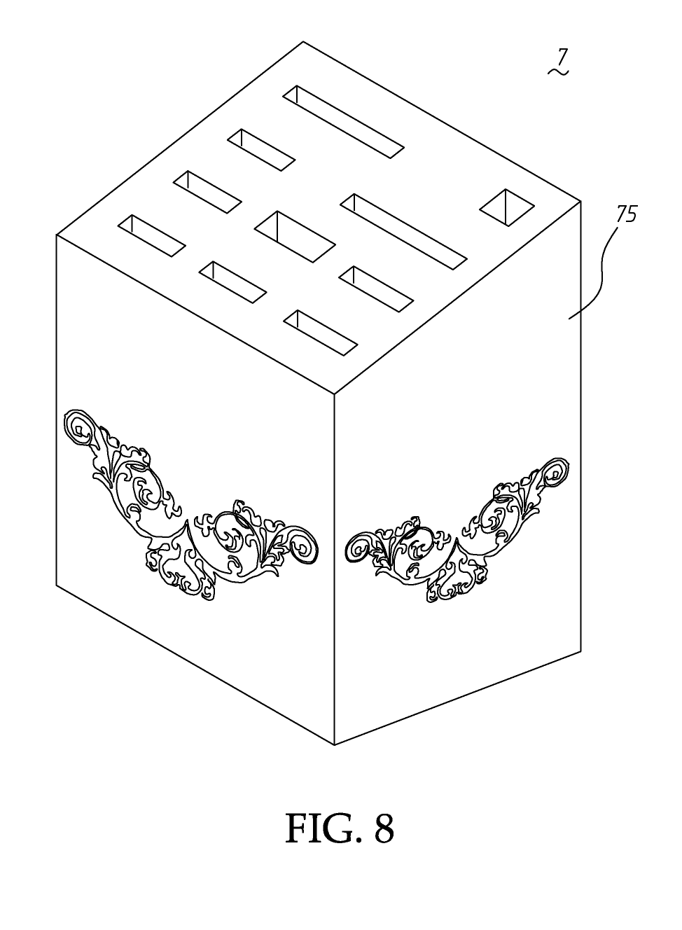

FIG. 8 is an elevational view of a cutter holder in accordance with a seventh embodiment of the present invention. According to this seventh embodiment, the outer surface of the holder block 70 of the cutter holder 7 is covered with a covering 75 that carries a design to attract people's eyes.

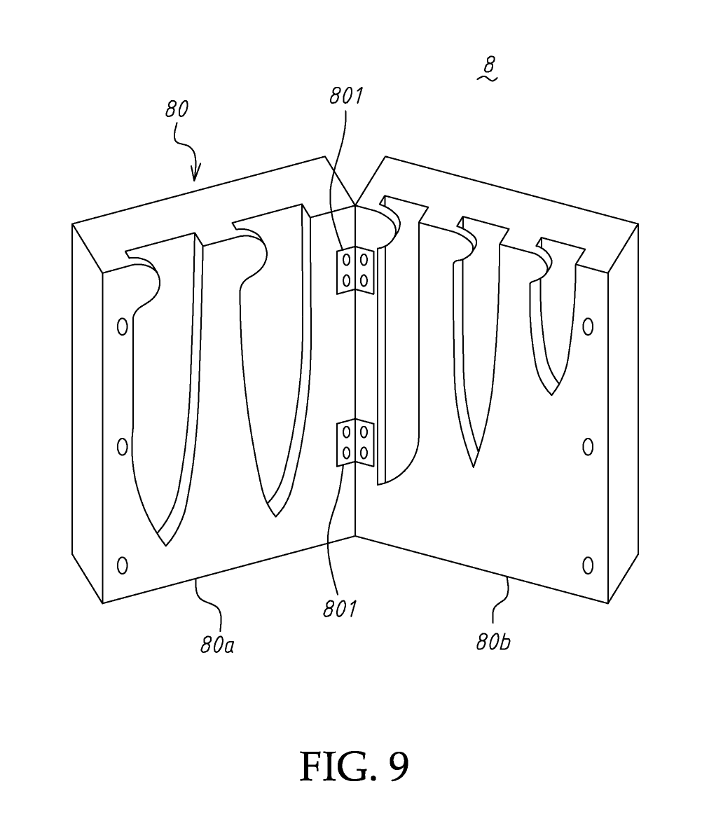

FIG. 9 illustrates a cutter holder in accordance with an eighth embodiment of the present invention. According to this eighth embodiment, the outer surface of the holder block 80 of the cutter holder 8 is formed of two cork material members 80a and 80b hinged together by hinges 801. Thus, the two cork material members 80a and 80b can be turned toward or apart from each other to close or open the holder block 80.

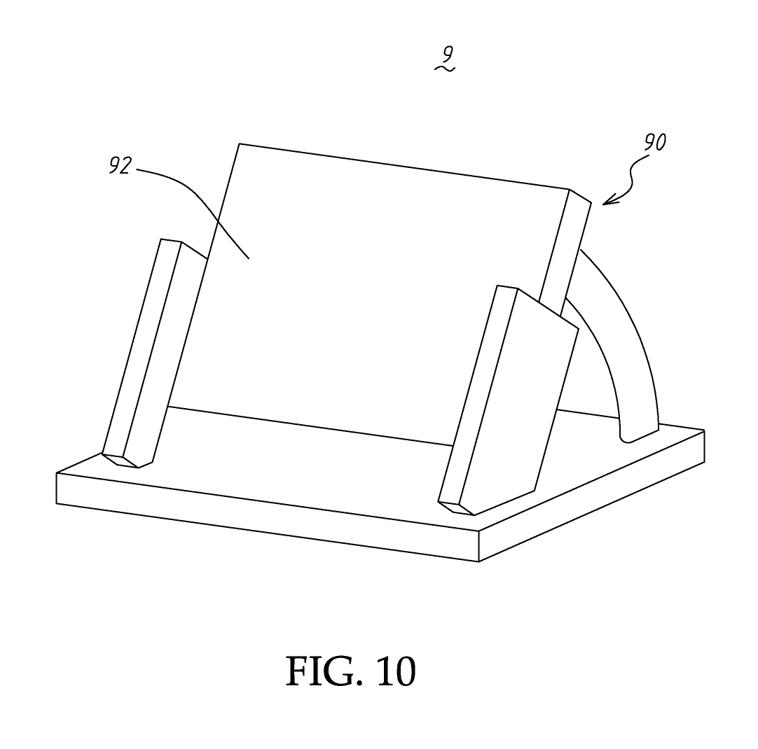

FIG. 10 is an elevational view of a cutter holder in accordance with a ninth embodiment of the present invention.

According to this ninth embodiment, the holder block 90 of the cutter holder 8 has one single insertion hole 92 that is an open design for holding multiple cutting tools of different sizes.

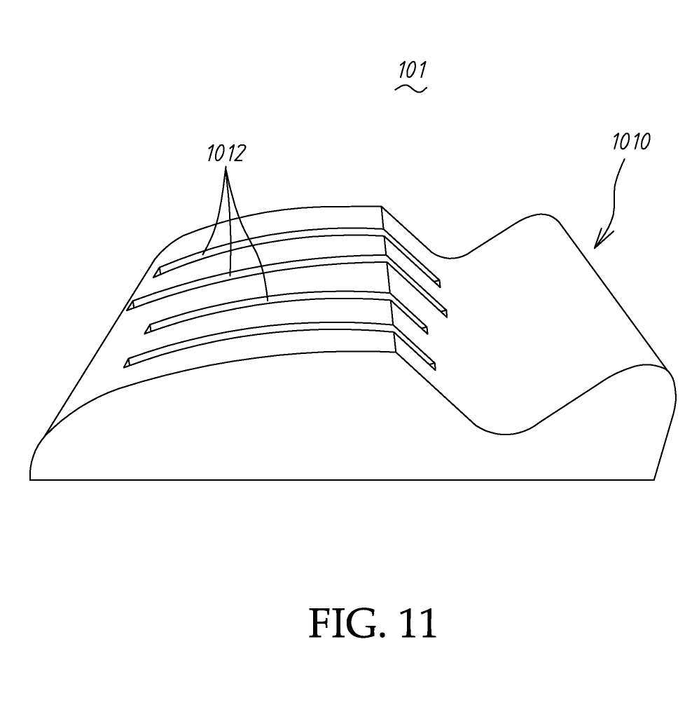

FIG. 11 is an elevational view of a cutter holder in accordance with tenth embodiment of the present invention. According to this tenth embodiment, the holder block 1010 of the cutter holder 101 is a horizontal block having multiple cutter-resting devices 1012 defined therein in horizontal.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A cutter holder, comprising a holder block made of cork material, said holder block having at least one insertion hole for the insertion of the cutter blade of at least one cutting tool.

2. The cutter holder as claimed in claim 1, wherein said holder block is formed of one single piece of cork material.

3. The cutter holder as claimed in claim 1, wherein said holder block is formed of multiple pieces of cork material.

4. The cutter holder as claimed in claim 1, wherein said holder block is formed of multiple pieces of cork material that are bonded together by an adhesive.

5. The cutter holder as claimed in claim 1, wherein each said insertion hole is attached with an internal sheath made of a different material relative to said cork material.

6. The cutter holder as claimed in claim 1, wherein said holder block is externally covered with a shell.

7. The cutter holder as claimed in claim 6, wherein said shell is a functional shell covered on a top wall of said holder block for protection.

8. The cutter holder as claimed in claim 6, wherein said shell is a functional shell covered on the whole outer surface of said holder block for protection.

9. The cutter holder as claimed in claim 1, wherein said holder is externally covered with a covering that carries a design.

10. The cutter holder as claimed in claim 1, wherein said holder comprises two symmetrical cork material members, and a hinge structure connecting said two symmetrical cork material members together.
